(19) United States
(12) Patent Application Publication
(10) Pub. No.: US 2013/0309477 A1
(43) Pub. Date: Nov. 21, 2013

(54) Laminated Cloth with Tourmaline

(71) Applicant: Chien-Chung Hu, Tainan (TW)

(72) Inventor: Chien-Chung Hu, Tainan (TW)

(21) Appl. No.: 13/476,088

(22) Filed: May 21, 2012

(51) Int. Cl. B32B 5/24

(52) U.S. Cl. 428/221

(57) ABSTRACT

A laminated cloth includes a cloth layer having a first side and a second side opposite to the first side. A thermally insulating rubber sheet includes a first surface and a second surface opposite to the first surface. An adhesive layer is bonded between the second side of the cloth layer and the first surface of the thermally insulating rubber sheet. An active cloth includes a cloth, with tourmaline powders adhered to the cloth. The active cloth includes a first face and a second face opposite to the first face. A tourmaline powders/adhesive layer is bonded between the second surface of the thermally insulating rubber sheet and the first face of the active cloth.

### BACKGROUND OF THE INVENTION

The present invention relates to a laminated cloth and, more particularly, to a laminated cloth with tourmaline for application in clothes for sports and workout.

Tourmaline is special mineral that possesses pyroelectricity and piezoelectricity. Specifically, tourmaline, when subjected to heat or pressure, generates minimal electric current and releases far-infrared rays that react with ambient water molecules to produce negative ions. In living goods, tourmaline can form fibers with natural tourmaline negative ions (which fibers are mixtures of tourmaline particles and polypropylene) or form electret fibers which are insoluble fibers including tourmaline particles uniformly distributed in polyvinyl alcohol (PVA).

Attempts have been made to produce clothes from cloths obtained from weaving fibers containing tourmaline. It is expected that the clothes containing tourmaline in contact with the body of the wearer can absorb the heat of the wearer to release far-infrared rays for the purposes of increasing the skin temperature and warming the body by increasing the blood circulation. However, gaps exist between the fibers of the cloths containing tourmaline, such that the ambient air can still pass through the gaps and come into contact with the body of the wearer, adversely affecting the body warming effect. In another approach, clothes are submersed in a liquid containing tourmaline powders. The tourmaline powders adhere to the cloths after drying. However, the tourmaline powders are liable to fall off from the clothes due to washing. Thus, the amount of tourmaline decreases gradually, adversely affecting the body warming effect of the cloths.

Thus, a need exists for a novel laminated cloth with tourmaline providing enhanced body warming effect.

### BRIEF SUMMARY OF THE INVENTION

A laminated cloth according to the present invention includes a cloth layer having a first side and a second side opposite to the first side. A thermally insulating rubber sheet includes a first surface and a second surface opposite to the first surface. An adhesive layer is bonded between the second side of the cloth layer and the first surface of the thermally insulating rubber sheet. An active cloth includes a cloth, with tourmaline powders adhered to the cloth. The active cloth includes a first face and a second face opposite to the first face. A tourmaline powders/adhesive layer is bonded between the second surface of the thermally insulating rubber sheet and the first face of the active cloth.

The thermally insulating rubber sheet can be styrene butadiene rubber or a thermoplastic elastomer. In an example, the tourmaline powders/adhesive layer includes 2-20 wt % of tourmaline powders and 80-98 wt % of liquid glue.

The laminated cloth can be used to produce various sports clothes for accumulation of heat, with the second face of the active cloth forming the inner side of the sport clothes. When a wearer wearing the sport clothes made from the laminated cloth, the tourmaline powders can emit far-infrared rays to stimulate the body of the wearer to give off heat and, thus, enhance the blood circulation. The body heat at the body portion wearing the sports clothes is insulated by the thermally insulating rubber sheet such that the heat energy can not easily dissipate from the body portion wearing the sports clothes that fits the wearer. Furthermore, the thermally insulating rubber sheet possesses excellent waterproof effect and excellent thermally insulating effect and, thus, can cause the body portion wearing the sports clothes to rapidly give off heat such that the body of the wearer can rapidly sweat and consume considerable body fats, providing better effect in workout and loosing weight.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a schematic cross sectional view illustrating production of a laminated cloth according to the present invention.

FIG. 2 shows an enlarged view of a circled portion in FIG. 1.

FIG. 3 shows a perspective view of a pair of shorts made from the laminated cloth according to the present invention.

FIG. 4 shows a perspective view of a pair of sports shorts made from the laminated cloth according to the present invention.

FIG. 5 shows a perspective view of a pair of sports pants made from the laminated cloth according to the present invention.

All figures are drawn for ease of explanation of the basic teachings only; the extensions of the figures with respect to number, position, relationship, and dimensions of the parts to form the illustrative embodiments will be explained or will be within the skill of the art after the following teachings have been read and understood. Further, the exact dimensions and dimensional proportions to conform to specific force, weight, strength, and similar requirements will likewise be within the skill of the art after the following teachings have been read and understood.

Where used in the various figures of the drawings, the same numerals designate the same or similar parts. Furthermore, when the terms “first”, “second”, “upper”, “lower”, “end”, “portion”, “side”, and similar terms are used herein, it should be understood that these terms have reference only to the structure shown in the drawings as it would appear to a person viewing the drawings and are utilized only to facilitate describing the illustrative embodiments.

### DETAILED DESCRIPTION OF THE INVENTION

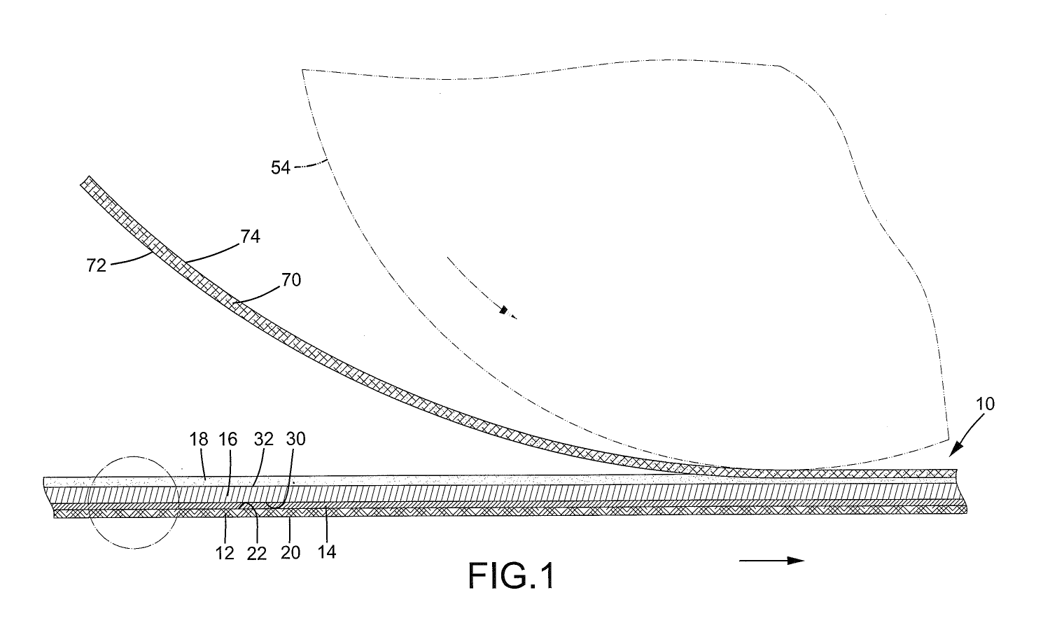

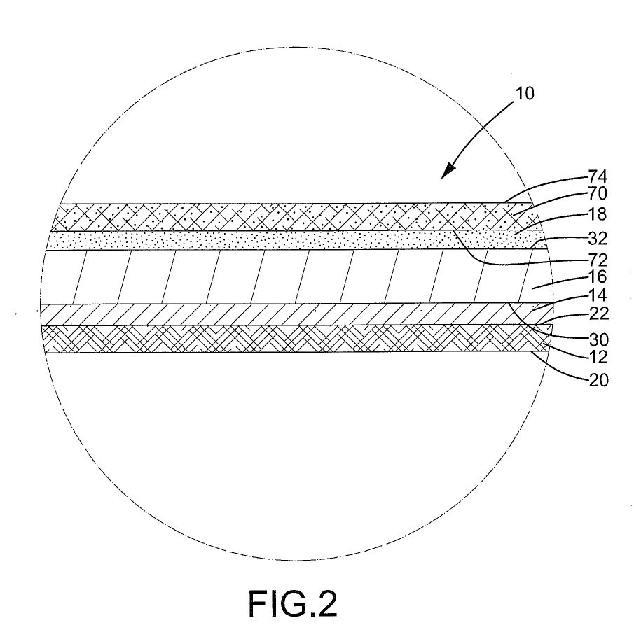

A laminated cloth with heat accumulation and temperature maintaining effect according to the present invention is shown in FIGS. 1 and 2 of the drawings and generally designated 10. Laminated cloth 10 includes a cloth layer 12, an adhesive layer 14, a thermally insulating rubber sheet 16, a tourmaline powders/adhesive layer 18, and an active cloth 70. Laminated cloth 10 can be used to produce sports clothes with enhanced effect in accumulation of heat and maintenance of temperature.

Cloth layer 12 can be woven fabric or nonwoven. Cloth layer 12 includes a first side 20 and a second side 22 opposite to first side 20.

Thermally insulating rubber sheet 16 includes a first surface 30 and a second surface 32 opposite to first surface 30. Thermally insulating rubber sheet 16 can be styrene butadiene rubber (SBR) or a thermoplastic elastomer (TPE). The styrene butadiene rubber is a copolymer of styrene and butadiene and includes properties of excellent insulation to heat and, thus, provides a warm keeping effect.

Adhesive layer 14 is a layer of a plastic adhesive or a resin of any desired type. Adhesive layer 14 is bonded between second side 22 of cloth layer 12 and first surface 30 of thermally insulating rubber sheet 16.

Active cloth 70 includes a cloth, with tourmaline powders attached to the cloth. Active cloth 70 includes a first face 72 and a second face 74 opposite to first face 72. Active cloth 70 containing tourmaline powders is obtained by submersing a cloth in a liquid containing tourmaline powders and then drying the cloth so that the tourmaline powders adhere to surfaces of the cloth.

Tourmaline powders/adhesive layer 18 is obtained by mixing liquid glue with tourmaline powders. Tourmaline powders/adhesive layer 18 includes 2-20 wt % of tourmaline powders and 80-98 wt % of liquid glue. The weight percentages of the tourmaline powders and liquid glue can be adjusted according to needs. Tourmaline powders/adhesive layer 18 is bonded between second surface 32 of thermally insulating rubber sheet 16 and first face 72 of active cloth 70.

In production of laminated cloth 10, first surface 30 of thermally insulating rubber sheet 16 is bonded by adhesive layer 14 to second side 22 of cloth layer 12. Tourmaline powders/adhesive layer 18 is then applied to second surface 32 of thermally insulating rubber sheet 16. Next, first face 72 of active cloth 70 is bonded by tourmaline powders/adhesive layer 18 to second surface 32 of thermally insulating rubber sheet 16 by a heating roller 54 through pressing (see FIG. 1). Thus, tourmaline powders/adhesive layer 18 is bonded between second surface 32 of thermally insulating rubber sheet 16 and first face 72 of active cloth 70.

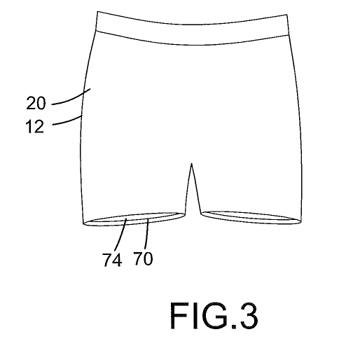

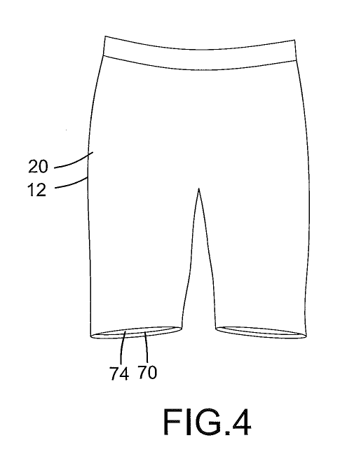

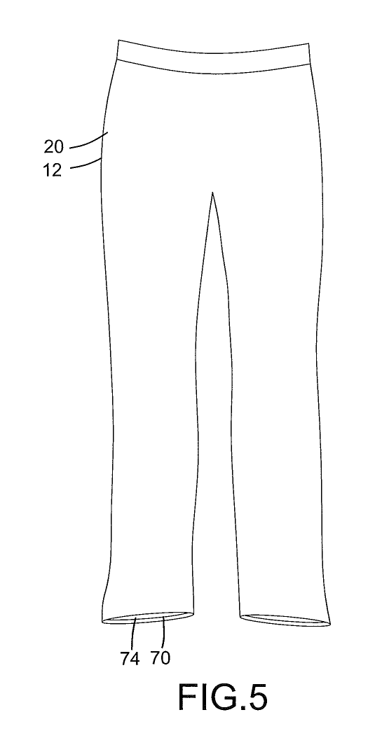

Laminated cloth 10 can be used to produce various sports clothes, such as shorts (FIG. 3), sports shorts (FIG. 4), and sports pants (FIG. 5) having various sizes and shapes for various customers. Second face 74 of active cloth 70 forms the inner side of the sport clothes made from laminated cloth 10. When a wearer wearing the sport clothes made from laminated cloth 10, second face 74 of active cloth 70 comes in contact with the skin of the wearer. Furthermore, tourmaline powders/adhesive layer 18 is adjacent to the skin of the wearer. The tourmaline powders can emit far-infrared rays to stimulate the body of the wearer to give off heat and, thus, enhance the blood circulation. The body heat at the body portion wearing the sports clothes is insulated by thermally insulating rubber sheet 16 such that the heat energy can not easily dissipate from the body portion wearing the sports clothes that fits the wearer. Furthermore, thermally insulating rubber sheet 16 possesses excellent waterproof effect and excellent thermally insulating effect and, thus, can cause the body portion wearing the sports clothes to rapidly give off heat such that the body of the wearer can rapidly sweat and consume considerable body fats. Thus, laminated cloth 10 provides synergistic results in accumulation and insulation of the heat, providing better effect in workout and loosing weight.

Since active cloth 70 is bonded to tourmaline powders/adhesive layer 18, even if the tourmaline powders in active cloth 70 fall off due to washing, the tourmaline powders on the first face 72 of active cloth 70 still adhere to tourmaline powders/adhesive layer 18. The tourmaline powders remaining on the first face 72 of active cloth 70 containing tourmaline powders and the tourmaline powders on tourmaline powders/adhesive layer 18 still provide a sufficient heat effect by emitting far-infrared rays to stimulate the body of the wear to give off heat.

Since tourmaline can generate electric current and creates an electric field, the water molecules in the electric field are electrolyzed into ions. Thus, the sports clothes made from laminated cloth 10 provide deodorization and an antibacterial effect due to the properties of ions.

Thus since the illustrative embodiments disclosed herein may be embodied in other specific forms without departing from the spirit or general characteristics thereof, some of which forms have been indicated, the embodiments described herein are to be considered in all respects illustrative and not restrictive. The scope is to be indicated by the appended claims, rather than by the foregoing description, and all changes which come within the meaning and range of equivalency of the claims are intended to be embraced therein.

1. A laminated cloth comprising:
a cloth layer including a first side and a second side opposite to the first side;
a thermally insulating rubber sheet including a first surface and a second surface opposite to the first surface;
an adhesive layer bonded between the second side of the cloth layer and the first surface of the thermally insulating rubber sheet;
an active cloth including a cloth, with tourmaline powders adhered to the cloth, with the active cloth including a first face and a second face opposite to the first face; and
a tourmaline powders/adhesive layer bonded between the second surface of the thermally insulating rubber sheet and the first face of the cloth containing tourmaline powders.

2. The laminated cloth as claimed in claim 1, with the thermally insulating rubber sheet being styrene butadiene rubber.

3. The laminated cloth as claimed in claim 2, with the tourmaline powders/adhesive layer including 2-20 wt % of tourmaline powders and 80-98 wt % of liquid glue.

4. The laminated cloth as claimed in claim 1, with the thermally insulating rubber sheet being a thermoplastic elastomer.
